(19) United States
(12) Patent Application Publication
(10) Pub. No.: US 2025/0086221 A1
(43) Pub. Date: Mar. 13, 2025

(54) DEVICE AND METHOD FOR SUPPORTING ANNOTATION GENERATION

(71) Applicant: MEDIAIPLUS CO., LTD., Seongnam-si (KR)

(72) Inventors: Yong Jang JO, Seongnam-si (KR); Nam Goo SONG, Suwon-si (KR); Ji Hee JUNG, Seoul (KR)

(21) Appl. No.: 18/960,041

(22) Filed: Nov. 26, 2024

Related U.S. Application Data
(63) Continuation-in-part of application No. PCT/KR2023/012624, filed on Aug. 25, 2023.

(30) Foreign Application Priority Data
Aug. 26, 2022 (KR) 10-2022-0107548

(51) Int. Cl. G06F 16/35; G06F 16/215; G06F 16/383

(52) U.S. Cl. CPC G06F 16/35; G06F 16/215; G06F 16/383

(57) ABSTRACT

An apparatus and a method for supporting generation of high-efficient annotation for massive data labeling are disclosed. An apparatus for supporting generation of annotation may include a labeling supporter which receives one or more raw data from a database to generate one or more labeling candidate information for each of one or more raw data and an interface which outputs one or more labeling candidate information.

### TECHNICAL FIELD

The present invention relates to an apparatus and a method for supporting generation of high-efficient annotation for massive data labeling.

### BACKGROUND

In recent years, as the applicable range of an artificial neural network has expanded, much research is being conducted on methods of generating learning data to learn the artificial neural network. The labeling technique for generating learning data of the related art is limited to an annotation system in a basic process of associating labels with data and such a system is limited to basic structures, such as a data input section, a data output section, and an annotation interface which implement the basic definition of the system.

However, such a basic function is not appropriate for various environments, such as a case when an amount of data exponentially increases or a high level of domain knowledge is required for a labeler to label data, or a case when a plurality of users participates as labelers and has different opinions on the labeling result.

### SUMMARY

### Technical Problem

An object of the present invention is to provide an apparatus and a method for supporting generation of high-efficient annotation for massive data labeling.

### Technical Solution

According to an aspect, an apparatus for supporting generation of annotation may include a labeling supporter which receives one or more raw data from a database to generate one or more labeling candidate information for each of one or more raw data; and an interface which outputs one or more labeling candidate information.

The labeling supporter may group one or more raw data based on at least one of one or more metadata included in the raw data and generate a list for reference metadata included in one or more raw data included in the same group.

The labeling supporter may measure a distance of metadata included in one or more raw data using a heuristic function, either the Euclidean distance or the Manhattan distance, or an edge hop on a graph based on reference metadata and group the raw data based on the measured distance of the metadata.

The labeling supporter may generate labeling candidate information by removing duplicate metadata, among metadata included in the list for the metadata, from the list.

The labeling supporter may generate identification information of the duplicate metadata using metadata other than the reference metadata.

The interface may output one or more labeling candidate information and receive an input signal to select any one of one or more labeling information from a user.

The labeling supporter may set metadata corresponding to the labeling candidate selected based on the input signal received through the interface to select labeling information as a label of one or more raw data included in the same group.

The raw data may be at least one of video data, text data, and image data.

The labeling supporter may receive an input signal to remove any one of one or more labeling information, from a user, through the interface and exclude raw data corresponding to a labeling candidate selected based on the received input signal to remove the labeling information from the group.

The labeling supporter may include a data labeling supporter which receives one or more raw data to perform any one of regression, classification, and clustering to generate an analysis vector; a data visualizer which converts the analysis vector into visual data; and a data integrity controller which performs voting on the analysis vector to generate labeling candidate information.

The labeling supporter may measure a distance of the metadata included in one or more raw data using an edit distance and when the metadata includes a proper noun, assign a weight to every type of the proper noun.

According to an aspect, a method for supporting generation of annotation may include a step of receiving one or more raw data from a database to generate one or more labeling candidate information for each of one or more raw data; and a step of outputting one or more labeling candidate information.

### Advantageous Effects

According to the exemplary embodiment, a high-efficient annotation system for massive data can be constructed and empirical problems occurring when the labeler performs the annotation system may be solved.

### BRIEF DESCRIPTION OF DRAWINGS

FIG. 1 is a diagram of an apparatus for supporting generation of annotation according to an exemplary embodiment.

FIG. 2 is an exemplary view for explaining a raw data grouping method according to an exemplary embodiment.

FIG. 3 is a diagram of a labeling supporter according to an exemplary embodiment.

FIG. 4 is an exemplary view for explaining an operation of a labeling supporter according to an exemplary embodiment.

FIG. 5 is a flowchart of a method for supporting generation of annotation according to an exemplary embodiment.

### DETAILED DESCRIPTIONS OF EXEMPLARY EMBODIMENTS

Hereinafter, an exemplary embodiment of the present invention will be described in detail with reference to the accompanying drawings. In the description of the present invention, a detailed description of known configurations or functions incorporated herein will be omitted when it is determined that the detailed description may make the subject matter of the present invention unclear. Further, the terms to be described below are defined considering the functions in the present invention and may vary depending on the intention or usual practice of a user or operator. Accordingly, the terms need to be defined based on details throughout this specification.

Hereinafter, exemplary embodiments of an apparatus and a method for supporting generation of annotation will be described in detail with reference to the drawings.

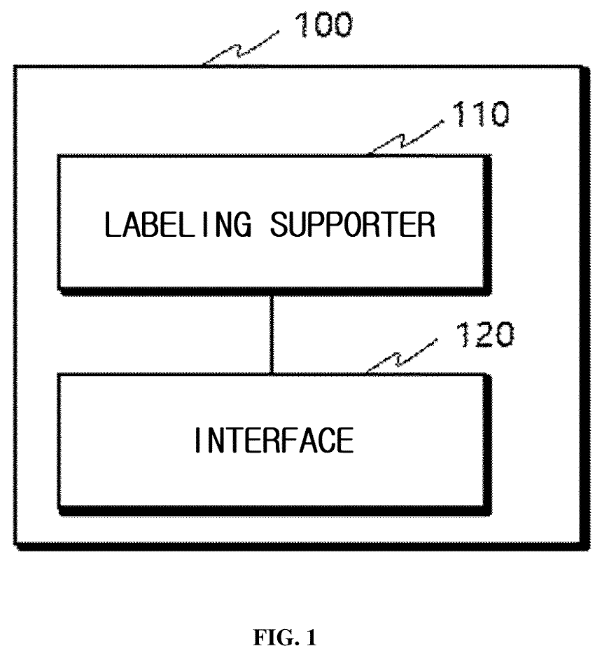

FIG. 1 is a diagram of an apparatus for supporting generation of annotation according to an exemplary embodiment.

Referring to FIG. 1, the apparatus 100 for supporting generation of annotation may include a labeling supporter 110 which receives one or more raw data from a database to generate one or more labeling candidate information about each of one or more raw data and an interface 120 which outputs one or more labeling candidate information.

According to the example, the raw data may be at least one of video data, text data, and image data. For example, the raw data may be paper data obtained by conducting clinical trials.

For example, the labeling candidate information may be information for distinguishing raw data. For example, if the raw data is paper data, the labeling candidate information may be at least one of an author, a creating organization, a creating date, a research topic, a research identification number, and a research field of the paper.

According to the exemplary embodiment, the labeling supporter 110 may group one or more raw data based on at least one of one or more metadata included in the raw data and generate a list for reference metadata which is included in one or more raw data included in the same group.

For example, the metadata may be data which becomes labeling candidate information. Accordingly, when the raw data is paper data, the metadata may be at least one of an author, a creating organization, a creating date, a research topic, a research identification number, and a research field of the paper.

According to an example, the labeling supporter 110 may group raw data based on any one of an author, a creating organization, a creating date, a research topic, a research identification number, and a research field of the paper included in the metadata. For example, when the reference metadata is the creating organization, the labeling supporter 110 may group paper data including a creating organization which is the same as or similar to the creating organization.

According to an example, the labeling supporter 110 may generate a metadata list which is a reference for grouping raw data included in the same group. For example, there are 10 raw data corresponding to a first group and each creating organization may be ‘University of Pennsylvania Hospital, Univ of Pennsylvania, University of Pennsylvannia, University of Pennsylvanica, Univ of Pennsylvania, University of Pennsylvania Faculty, University of Pensylvania, Univesity of Pennsylvania, University of Pennsylvania, and University of Pennsylvania Hospital’. In this case, the labeling supporter 110 may generate a metadata list using metadata for the above-mentioned creating organization.

According to an exemplary embodiment, the labeling supporter 110 may measure a distance of metadata included in one or more raw data based on the reference metadata and group the raw data based on the measured distance of metadata.

For example, the labeling supporter 110 may measure a distance of metadata included in one or more raw data using a heuristic function, either the Euclidean distance or the Manhattan distance, or an edge hop on a graph.

For example, the labeling supporter 110 may measure a distance of the metadata using an edit distance. For example, if metadata a is “How are you” and metadata b is “How are you doing”, the distance between two metadata is 5, based on “doing” having different syllable between metadata.

For example, the labeling supporter 110 may assign a weight to every type of proper noun when the distance of the metadata is measured using an edit distance. For example, when metadata including proper nouns such as names of people, names of organizations, place names, and names of countries is input, the labeling supporter 110 may assign a predetermined weight designated for each proper noun through a predetermined function designated for each type of proper noun included in the metadata. For example, when two metadata includes proper nouns for names of people and place names, the labeling supporter 110 may apply differently a weight for different names of people and a weight for different place names.

For example, the metadata may be configured by a sentence including one or more words or a string including one or more characters.

For example, the labeling supporter 110 may assign different weights to a distance according to replacement, insertion, deletion, and reordering.

For example, when metadata is “Winikoff, Beverly” and “Winikoff, B”, two metadata may have a relationship in which “everly” is added or deleted. In contrast, when two metadata “Winikoff, Gray” and “Winikoff, B”, “Grey” and “B” have a “replacement” relationship. In two cases, “addition or deletion” is an abbreviation of a name and is highly likely to mean the same name, but “replacement” is likely to mean different names. Accordingly, for the “addition or “deletion”, a weight for a distance may be set to be small and for the “replacement”, a weight for a distance may be set to be large.

For example, in the case of the metadata “Beverly Winikoff” and “Winikoff Beverly”, the orders of two words “Winikoff” and “Beverly” are different so that if the orders of two words are changed, they may be the same metadata. Accordingly, when two metadata have a “reordering” relationship, a weight for the distance may be set to be small.

According to the exemplary embodiment, the labeling supporter 110 removes duplicate metadata among metadata included in the list for metadata from the list to generate labeling candidate information.

For example, in the above-mentioned first group, metadata, University of Pennsylvania Hospital, University of Pennsylvania, and Univ of Pennsylvania, is duplicated. At this time, the labeling supporter 110 removes the duplicate metadata from the list to generate labeling candidate information.

For example, the labeling candidate information may be generated as represented in the following Table.

TABLE 1

| Labeling candidate information | User's choice input |
|---|---|
| University of Pennsylvania Hospital | University of Pennsylvania |
| Univ of Pennsylvania | |
| University of Pennsylvannia | |
| University of Pennsylvania | |
| University of Pennsylvania Faculty | |
| University of Pensylvania | |
| Univesity of Pennsylvania | |

According to the exemplary embodiment, the interface 120 may output one or more labeling candidate information and receive an input signal to select any one of one or more labeling information from a user.

For example, as represented in Table 1, the interface 120 may receive and output seven labeling candidate information from the labeling supporter 110 and receive an input to select one from the labeling candidate information output from the user. For example, the interface 120 may receive an input signal from the user to select ‘University of Pennsylvania’ from seven labeling candidate information.

According to the exemplary embodiment, the labeling supporter 110 may set metadata corresponding to a labeling candidate selected based on an input signal to select labeling information received through the interface 120 as a label of one or more raw data included in the same group.

For example, for all ten raw data included in the first group corresponding to the labeling candidate information represented in Table 1, the same label “University of Pennsylvania” may be set.

According to the exemplary embodiment, the labeling supporter 110 may receive an input signal to remove any one of one or more labeling information from the user through the interface 120 and exclude raw data corresponding to a labeling candidate selected based on the received input signal to remove the labeling information, from the group.

For example, when the labeling supporter 110 receives a request for an input to remove “‘University of Pennsylvania Hospital” from seven labeling candidate information from the interface 120, the labeling supporter 110 may remove the corresponding information from the labeling candidate information and output six labeling candidate information. Further, the labeling supporter 110 may remove the raw data including the removed metadata “‘University of Pennsylvania Hospital” from the first group.

According to the exemplary embodiment, the labeling supporter 110 may generate identification information of the duplicate metadata using other metadata than the reference metadata.

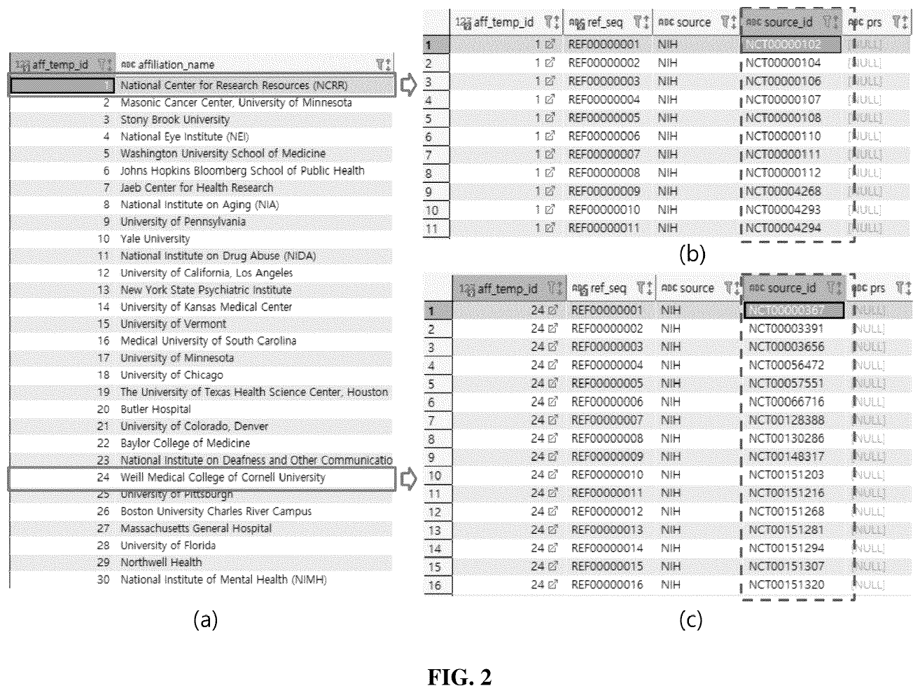

For example, the labeling supporter 110 may utilize a research identification number other than the creating organization which is applied as a reference in the above-exemplary embodiment, as identification information. For example, raw data corresponding to “‘National Center for Research Resources (NCRR)” of FIG. 2A may be represented as in FIG. 2B and 11 raw data may be identified based on “source id”. As another example, for example, raw data corresponding to “‘Weill Medical College of Cornell University” of FIG. 2A may be represented as in FIG. 2C and 16 raw data may be identified based on “source id”.

### Mode for Carrying Out the Invention

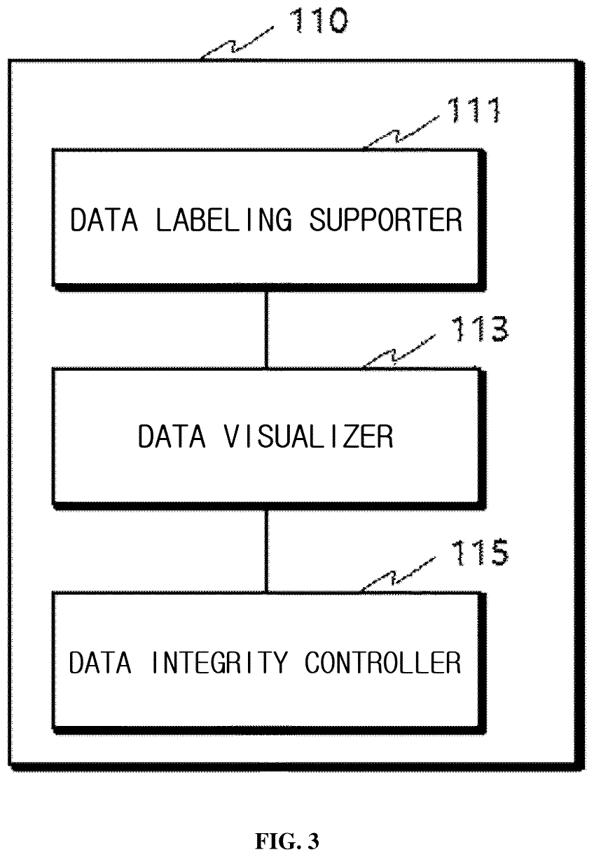

FIG. 3 is a diagram of a labeling supporter according to an exemplary embodiment.

Referring to FIG. 3, the labeling supporter 110 may include a data labeling supporter 111, a data visualizer 113, and a data integrity controller 115.

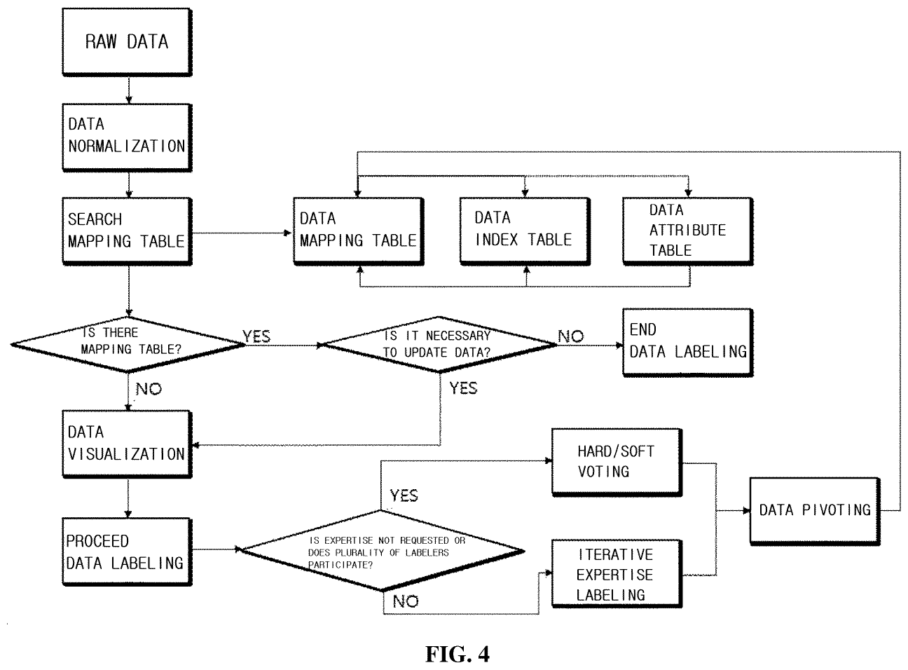

FIG. 4 is an exemplary view for explaining an operation of a labeling supporter according to an exemplary embodiment.

According to an example, the data labeling supporter 111 may perform all processes which are performed right up until data visualization during the labeling. The data labeling supporter 111 may receive raw data and output a vector including a complex value as a result. For example, the raw data may include structured and unstructured data such as videos, texts, and images.

For example, in the case of the raw data such as videos or images, a metadata distance may be calculated using a difference in distribution, such as an object distance in an image foreground, a triplet loss, a heuristic distance between two images, Kullback-Leibler divergence (KL divergence) or a cross entropy.

For example, the data labeling supporter 111 may include a model or a machine learning model. For example, the machine learning model may be any one of a supervised learning model, an unsupervised learning model, and a reinforcement learning model. As another example, the data labeling supporter 111 may be implemented as a Rule-base model and apply different weights to features according to a type of features extracted from the source data. Here, when the weight is applied to the feature, it means that an arbitrarily set value is multiplied with a feature calculated as a vector.

For example, the data labeling supporter 111 may analyze input raw data simultaneously using a plurality of machine learning models or a plurality of Rule-base models and results output from the plurality of models may be utilized by the Ensemble method.

For example, the result vector output from the data labeling supporter 111 is used as an input for data visualization and may also be used as a condition value which affects the visualization result. Further, an output result of each model may correspond to one of regression, classification, and clustering, and may be shown as preliminary inference and preliminary clustering results in the data visualization step. In other words, data (unlabeled data) which is not labeled until the user assigns a label to data may have an inference result value of a pre-trained model in a similar dataset as a default.

For example, among the vectors extracted as a clustering result, a relative distance of data which are difficult to be labeled by the model in advance may be extracted by calculating the Euclidean distance between data or the edge hop on the graph. At this time, the data labeling supporter 111 may use an algorithm or metric which calculates a relative distance (or difference in distribution), such as fuzzy matching, cosine similarity, edit distance, cross-entropy, and Kullback-Leibler divergence.

According to an example, the data visualizer 113 may perform an operation of transmitting a model result vector generated in the data labeling supporter 111 to a terminal of a client and visualizing the model result vector according to a condition, to transmit the labeling result to the server again to be stored in an annotation history table. Here, the user of the client may be a labeler who performs the annotation and communication between a server and a client may include all communication methods including wired/wireless methods. Further, the terminal indicates an electronic device which is capable of performing wired/wireless communication to allow a labeler to perform annotation.

For example, the data visualizer 113 may perform bi-directional parameter transmission between a server and a client to perform annotation. For example, parameters which are transmitted to RestfulAPI in http, https protocol communication may correspond thereto.

According to an example, the data visualizer 113 may express a model result vector to be transmitted to the client and unlabeled data as colors, diagrams, shapes, scales, interactions, events expressed on the program, texts, videos, and sounds. At this time, the output may be expressed differently depending on a data visualization condition clause and a model result vector value.

According to an example, the data visualizer 113 may replace unlabeled data which is transmitted to the client with an inference result of the model before the labeler performs the task to make the data labeled.

According to an example, when the result of the model is ‘clustering’ rather than ‘regression’ or ‘classification’, the client may collect unlabeled data with a short distance between vectors together.

According to an example, data which is completely annotated by the labeler is transmitted to the server again and may be stored in a temporary annotation table. The unlabeled data provided from the server may include reference information required to understand data, such as the data itself, a source data source of the unlabeled data, and a feature of the data.

According to an example, when the labeler cannot clearly classify data to be labeled to a certain class, the labeler may skip the data or label the data as a specific exceptional class. Whenever the labeler performs the annotation, the labeler may be provided with an annotation progress, a skip count, exceptional class information, and annotation execution manual from the server.

According to an example, the data integrity controller 115 is a logical device which minimizes gaps or human errors on the data which may be labeled differently when one or a plurality of users or labelers having different expertise levels participate.

According to an example, a labeling result of the client is stored in a temporary table and an annotation result stored in the temporary table is divided to be stored in a data mapping table, a data index table, and a data attribute table by a specific trigger or condition.

For example, the data mapping table is a table in which information about how source or raw data is mapped to what identifiable data in the end is recorded and may perform a function of preventing labelers from relabeling the same source or raw data in the future. Accordingly, it is specifically required to construct an annotation system for massive data and it allows unstructured data to be identified as a structured form through the table in the real-time service.

For example, each element of the data index table is one entity to which raw data is actually labeled and each entity is semantically independent and has a unique key value. In other words, raw data which is input in real time passes through the mapping table to be confirmed which key is connected thereto and then is identified from the data index table.

For example, the data attribute table is a table which is configured by characteristics or features for each entity of the data index table. Features for the identified entity may be defined in the corresponding table.

According to an example, a labeling result of the client may be stored in a table by two methods, according to characteristics of the data or the number of labelers. For example, when the expertise is not required to label the data or a plurality of labelers participates, a hard voting or soft voting technique which is one of machine learning techniques of the related art may be used.

Here, according to the hard voting, when a plurality of labelers annotates one data with two types (or classes) of names, the result is determined by majority vote. According to the soft voting, a plurality of labelers assigns different real numbers to a probability of belonging to each class for one data and a class of data is finally determined by weighting (for example, a weight is determined according to a domain knowledge level) the real-number labeling values of a plurality of labelers.

For example, an iterative expertise labeling method may be used when expertise is required to label the data and the number of labelers is small. According to the iterative expertise labeling, labeling steps are divided according to the domain knowledge level and an annotation set is performed according to the knowledge level and then the result of each set is passed to the higher domain expert group, thereby repeating the same annotation set multiple times.

For example, all the hard voting, the soft voting, and the iterative expertise labeling method are techniques for minimizing domain knowledge gaps or human errors and the data labeling supporter 111, the data visualizer 113, and the data integrity controller 115 are minimum functions required to implement an annotation system for massive data.

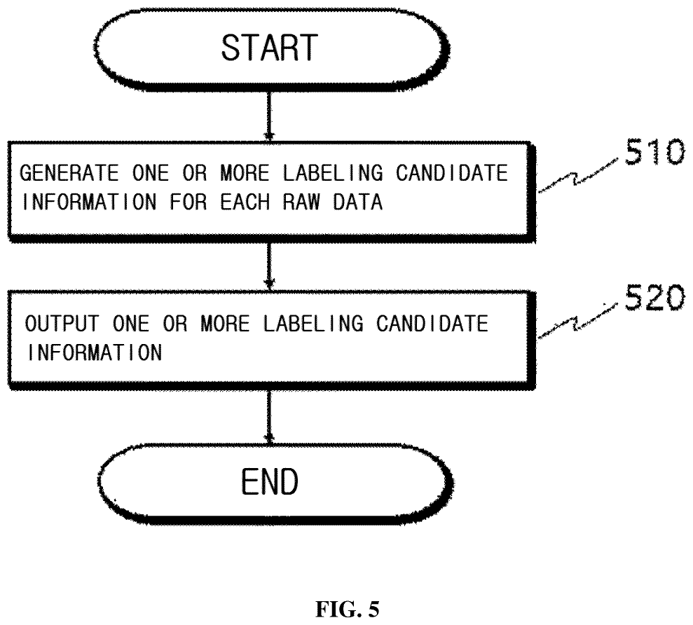

FIG. 5 is a flowchart of a method for supporting generation of annotation according to an exemplary embodiment.

According to an exemplary embodiment, the apparatus for supporting generation of the annotation receives one or more raw data from a database to generate one or more labeling candidate information for one or more raw data in step 510. Thereafter, the apparatus for supporting generation of the annotation may output one or more labeling candidate information to the user in step 520.

Among the exemplary embodiments of FIG. 5, exemplary embodiments that overlapped the contents described with reference to FIGS. 1 to 4 were omitted.

An aspect of the present invention may also be implemented as computer-readable codes written on a computer-readable recording medium. Codes and code segments which implement the program may be easily deducted by a computer programmer in the art. The computer readable recording medium may include all kinds of recording devices in which data, which are capable of being read by a computer system, are stored. Examples of the computer-readable recording media may include ROM, RAM, CD-ROM, magnetic tape, floppy disk, optical disk, and the like. Further, the computer-readable recording medium is distributed in computer systems connected through a network to be written and executed with a computer-readable code in a distributed manner.

For now, the present invention has been described with reference to the exemplary embodiments. It is understood to those skilled in the art that the present invention may be implemented as a modified form without departing from an essential characteristic of the present invention. Accordingly, the scope of the present invention is not limited to the above-described embodiment, but should be construed to include various embodiments within the scope equivalent to the description of the claims.

### Industrial Applicability

The present invention is applicable to the field of a data industry.

1. An apparatus for supporting generation of annotation, comprising:
a labeling supporter which receives one or more raw data from a database to generate one or more labeling candidate information for each of the one or more raw data; and
an interface which outputs the one or more labeling candidate information,
wherein the labeling supporter determines any one of types of one or more metadata included in each of the one or more raw data as a reference, measures a distance between the metadata included in the one or more raw data corresponding to a type of the reference metadata using a heuristic function, either the Euclidean distance or the Manhattan distance, or an edge hop on a graph, groups the one or more raw data based on the measured distance of the metadata, generates the one or more labeling candidate information including a list for the metadata corresponding to the type of the reference metadata for every group, receives an input signal to select any one metadata included in the list for the metadata for every group from a user, by means of the interface, and changes metadata other than the metadata selected for every group, among the one or more metadata corresponding to the type of the reference metadata into the metadata selected for every group.

2. The apparatus for supporting generation of annotation according to claim 1, wherein the labeling supporter generates the labeling candidate information by removing duplicate metadata, among the metadata included in the list for the metadata, from the list.

3. The apparatus for supporting generation of annotation according to claim 2, wherein the labeling supporter generates identification information of the duplicate metadata using metadata other than the reference metadata.

4. The apparatus for supporting generation of annotation according to claim 1, wherein the raw data is at least one of video data, text data, and image data.

5. The apparatus for supporting generation of annotation according to claim 1, wherein the labeling supporter receives an input signal to remove any one of the one or more labeling information, from the user, through the interface and excludes raw data corresponding to a labeling candidate selected based on the received input signal to remove the labeling information, from the group.

6. The apparatus for supporting generation of annotation according to claim 1, wherein the labeling supporter includes:
a data labeling supporter which receives the one or more raw data to perform any one of regression, classification, and clustering to generate an analysis vector;
a data visualizer which converts the analysis vector into visual data; and
a data integrity controller which performs voting on the analysis vector to generate the labeling candidate information.

7. The apparatus for supporting generation of annotation according to claim 1, wherein the labeling supporter measures a distance of the metadata included in the one or more raw data using an edit distance and when the metadata includes a proper noun, assigns a weight to every type of the proper noun.

8. A method for supporting generation of annotation which is carried out in an apparatus for supporting generation of annotation including one or more processors and a memory which stores one or more programs executed by the one or more processors, the method comprising:
generating one or more labeling candidate information for each of one or more raw data by receiving the one or more raw data from a database; and
outputting the one or more labeling candidate information by means of an interface,
wherein in the generating labeling candidate information, any one of types of one or more metadata included in each of the one or more raw data is determined as a reference, a distance between the metadata included in the one or more raw data corresponding to a type of the reference metadata is measured using a heuristic function, either the Euclidean distance or the Manhattan distance, or an edge hop on a graph, the one or more raw data is grouped based on the measured distance of the metadata, the one or more labeling candidate information including a list for the metadata corresponding to the type of the reference metadata for every group is generated, an input signal to select any one metadata included in a list for the metadata for every group from a user is received by means of the interface, and metadata other than the metadata selected for every group, among the one or more metadata corresponding to the type of the reference metadata is changed into the metadata selected for every group.

9. The method for supporting generation of annotation according to claim 8, wherein in the generating labeling candidate information, the labeling candidate information is generated by removing duplicate metadata, among the metadata included in the list for the metadata, from the list.

10. The method for supporting generation of annotation according to claim 9, wherein in the generating labeling candidate information, identification information of the duplicate metadata is generated using metadata other than the reference metadata.

11. The method for supporting generation of annotation according to claim 8, wherein the raw data is at least one of video data, text data, and image data.

12. The method for supporting generation of annotation according to claim 8, wherein in the outputting labeling candidate information, an input signal to remove any one of the one or more labeling information is received from the user, through the interface and raw data corresponding to a labeling candidate selected based on the received input signal to remove the labeling information is excluded from the group.

13. The method for supporting generation of annotation according to claim 8, wherein in the outputting labeling candidate information, the one or more raw data is received to perform any one of regression, classification, and clustering to generate an analysis vector, the analysis vector is converted into visual data, and voting is performed on the analysis vector to generate the labeling candidate information.

14. The method for supporting generation of annotation according to claim 8, wherein in the outputting labeling candidate information, a distance of the metadata included in the one or more raw data is measured using an edit distance and when the metadata includes a proper noun, a weight is assigned to every type of the proper noun.
